(19) United States
(12) Patent Application Publication
(10) Pub. No.: US 2011/0182054 A1
(43) Pub. Date: Jul. 28, 2011

(54) LIGHT SOURCE MODULE

(75) Inventors: Wan-Yi LEE, Shulin City (TW); Chia-Ying TSENG, Shulin City (TW); Yu-Yuan HUANG, Shulin City (TW); Jin-Yong LIOU, Shulin City (TW)

(73) Assignee: JMK OPTOELECTRONIC. CO., LTD.

(21) Appl. No.: 12/821,265

(22) Filed: Jun. 23, 2010

(30) Foreign Application Priority Data
Jan. 26, 2010 (TW) 099201558

(51) Int. Cl. F21V 9/16; F21V 1/00

(52) U.S. Cl. 362/84; 362/235

(57) ABSTRACT

The present invention provides a light source module. The light source module includes a circuit board, a metal base, a plurality of LEDs, a plurality of bonding wires and a reflective layer. The metal base is arranged on the circuit board and has a bottom wall and a peripheral wall upwardly extending from the bottom wall. The bottom wall and the peripheral wall cooperatively define a recess. The bottom wall has a through groove exposing the circuit board. The LEDs are arranged on the bottom wall. The bonding wires electrically connect the LEDs to the circuit board through the through groove. The reflective layer is arranged in the through groove and seals the through groove. Therefore, the light source module has better heat dissipation effect and the overall illumination intensity of the light source module is increased.

### BACKGROUND OF THE INVENTION

1. Field of the Invention

The present invention relates to a light source module, especially relates to a light source module using light emitting diodes.

2. Description of Related Art

Since the maximum illumination intensity of a single light emitting diode (LED) is limited, a plurality of light emitting diodes are usually arranged together on a circuit board to form a LED light source module with sufficient illumination intensity, such that the light source module is able to provide illumination for a larger area.

Refer to FIG. 1, an example of the above-mentioned LED light source module is depicted. In the LED light source module, a circuit board for arranging LEDs thereon includes a base 11, an insulating layer 12 arranged on the base 11, and a plurality of conductive traces 13 disposed on the insulating layer 12. The base 11 is made of metal material for absorbing heat generated from LEDs 14. Thus, the temperature of LEDs can be cooled down, which helps LEDs remain the same illumination efficiency while operating. The LEDs 14 are arranged on the insulating layer 12. A plurality of bonding wires are used for connecting the LEDs 14 to the conductive traces 13. In addition, an outer frame 16 for redirecting light is arranged on the insulating layer 12 and surrounds the conductive traces 13 and the LEDs 14. An encapsulant 17 is provided to cover the LEDs 14 and the bonding wires 15. In practical operation, heat generated from the LEDs 14 is transferred through the insulting layer 12 to the base 11 and the outer frame 16, which helps dissipating heat and prevents the illuminating efficiency of the LEDs 14 from dropping.

However, since significant footprint on the insulating layer 12 is already occupied by the conductive traces 13, there is no more possibility to arrange more LEDs 14 on the insulating layer 12. That makes the overall illumination intensity of the light source module have no chance for further improvement. Besides, since the layout of the conductive traces 13 must detour the LEDs 14, the difficultness of the arranging those conductive traces 13 is raised. Further, due to the limitation on arranging more LEDs 14, the pitch between adjacent LEDs 14 can not be further reduced. In multi-color applications, LEDs 14 with different colors are arranged adjacently for the purpose of color-mixing. The minimum distance for fully mixing is positively proportional to the pitch between adjacent LEDs 14. However, since the pitch between adjacent LEDs 14 can not be shortened any more, the minimum distance for fully color mixing can not be shortened either. Besides, the illumination uniformity of the light source module is slightly affected for a portion of light is disorderly reflected from the conductive traces 13.

### SUMMARY OF THE INVENTION

Therefore, the objective of the present invention provides a light source module. The LEDs and conductive traces of the light source module are arranged on two levels with different heights, such that more LEDs can be added to increase the total illumination intensity of the light source module and the layout of the conductive traces will not be affected by LEDs.

Accordingly, the present invention provides a light source module. The light source module includes a circuit board, a metal base, a plurality of LEDs, a plurality of bonding wires and a reflective layer. The metal base is arranged on the circuit board and has a bottom wall and a peripheral wall upwardly extending from the bottom wall. The bottom wall and the peripheral wall cooperatively define a recess. The bottom wall has a through groove exposing the circuit board. The LEDs are arranged on the bottom wall. The bonding wires electrically connect the LEDs to the circuit board through the through groove. The reflective layer is arranged in the through groove and seals the through groove.

Since the LEDs are not arranged on the circuit board, but are arranged on the bottom wall of the metal base and electrically connected to the circuit board by the bonding wires, heat generated from the LEDs in operation can be directly transferred to the metal base. Thus, the heat dissipating efficiency is better. In addition, since there is no LEDs on the circuit board, the layout of the trace of the circuit board is easier and more LEDs can be arranged close to each other to increase the total illumination intensity of the light source module.

### BRIEF DESCRIPTION OF THE DRAWINGS

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a cross-sectional view of a conventional light source module;

FIG. 2 is a schematic view of an embodiment of the light source module of the present invention;

FIG. 3 is a cross-sectional view of the light source module in FIG. 2;

FIG. 4 is a cross-sectional view of another embodiment of the light source module of the present invention;

FIG. 5 is a cross-sectional view of another embodiment of the light source module of the present invention;

FIG. 6 is a cross-sectional view of another embodiment of the light source module of the present invention;

FIG. 7 is a cross-sectional view of another embodiment of the light source module of the present invention;

FIG. 8 is a cross-sectional view of another embodiment of the light source module of the present invention;

FIG. 9 is a cross-sectional view of another embodiment of the light source module of the present invention;

FIG. 10 is a cross-sectional view of another embodiment of the light source module of the present invention; and

FIG. 11 is a top view of another embodiment of the light source module of the present invention.

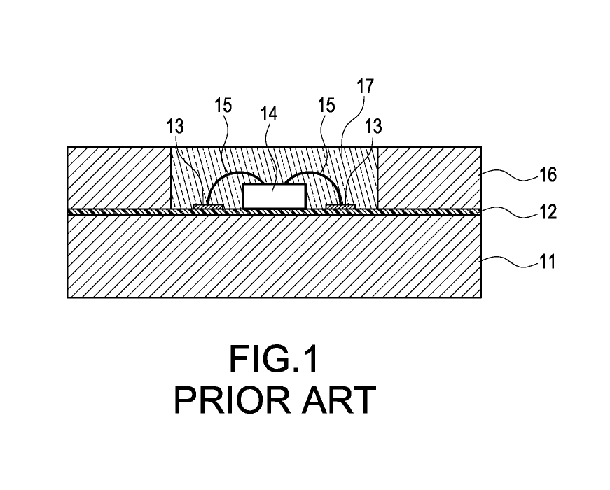

### DETAILED DESCRIPTION OF THE INVENTION

In cooperation with attached drawings, the technical contents and detailed description of the present invention are described thereinafter according to a number of embodiments, not used to limit its executing scope. Any equivalent variation and modification made according to appended claims is all covered by the claims claimed by the present invention.

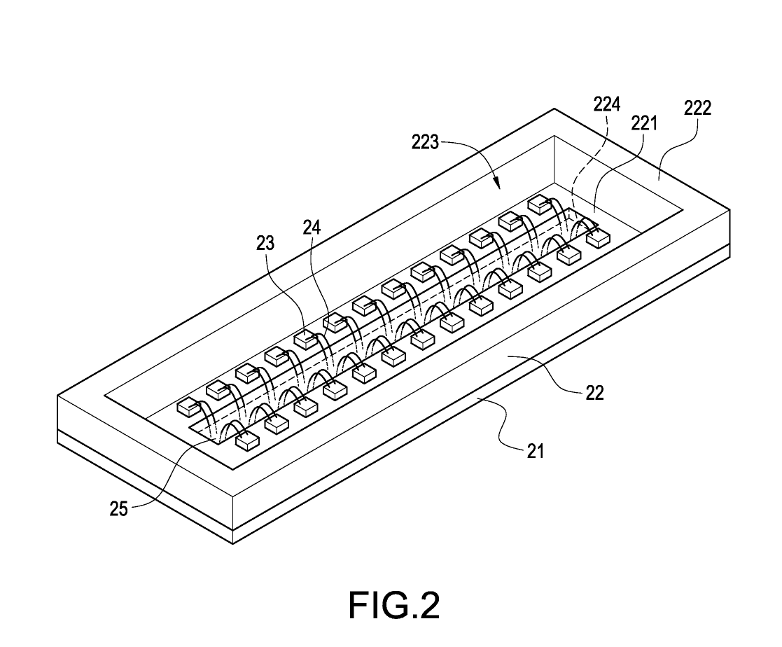

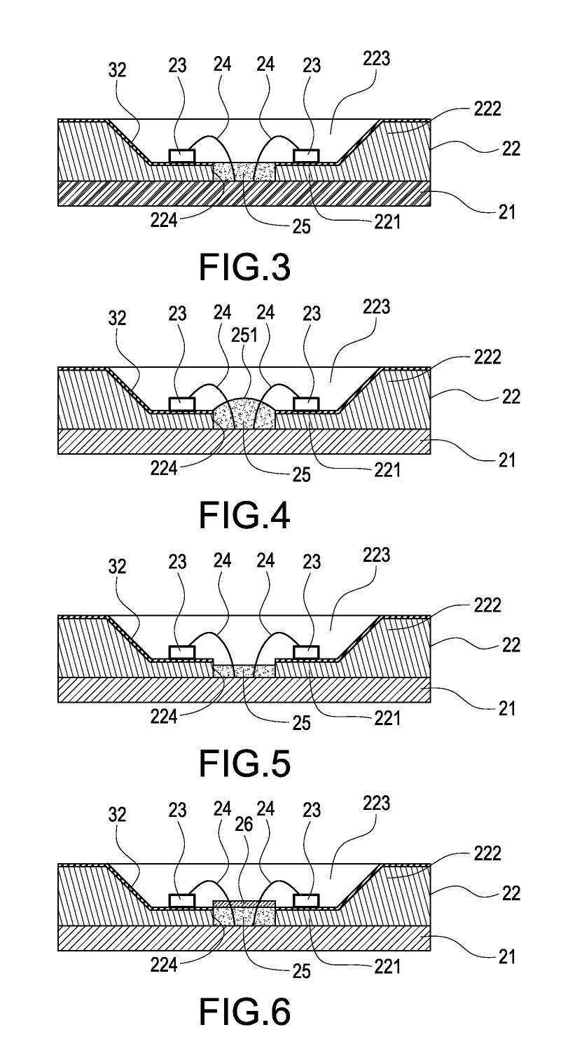

FIG. 2 and FIG. 3 illustrate an embodiment of the light source module of the present invention. The light source module mainly includes a circuit board 21, a metal base 22, a plurality of LEDs 23, a plurality of bonding wires 24, and a reflective layer 25.

The circuit board 21 is of rectangular shape and has a plurality of conductive traces and pads (not shown) arranged on the upper surface of the circuit board 21. The circuit board 21 can be a single layer PCB, multilayer PCB, aluminum based PCB, or flexible PCB. In addition, a plurality of electronic components can be further arranged on the lower surface of the circuit board 21. The electronic components can be drive chips or control chips or other kinds of electronic components. The electronic components can be electrically connected to the conductive wires on the upper surface of the circuit board 21 through internal or external traces of the circuit board 21. Thus, the LEDs 23 can be electrically connected to the drive chip or other electronic components on the lower surface. Since both the upper surface and lower surface can be utilized, the total size of the light source module can be further reduced.

The metal base 22 is arranged on the circuit board 21 and is of rectangular shape. The metal base 22 has a bottom wall 221 and a peripheral wall 222 upwardly extending from the bottom wall 221. The bottom wall 221 and the peripheral wall 222 cooperatively define a recess 223. The bottom wall 221 has a through groove 224 exposing the circuit board 21. The metal base 22 can be made of heat dissipating materials like aluminum or copper.

Generally speaking, the metal base 22 is usually made from various kinds of mechanical means and the surface roughness of the metal base 22 is usually poor. In present invention, an optical layer 32 can be further formed on the metal base 22 to improve the surface roughness. The optical layer 32 is made by curing dye-doped liquid material disposed on the metal base. The liquid material can be silicone or resin like epoxy resin. The dye can be photo curable ink or thermal curable ink. In other embodiment, the optical layer 32 can also be made of mixture of barium sulphate. Since the optical layer 32 has better surface roughness, light reflectance on the optical layer 32 is better. The dye has effect of varying the color of light reflected therefrom. Warmer or colder colors can thus be obtained to satisfy users from different nations. In practical manufacturing, a metal plate is provided, and then the optical layer 32 is formed on the metal plate, and then the metal plate with the optical layer 32 is stamp-molded to obtain the metal base 22. Techniques for forming the optical layer 32 is not limited, which can be coating, printing, evaporating or sputtering.

The LEDs 23 are arranged in the recess 223 and attached on the bottom wall 221 of the metal base 22. The bonding wires 24 are provided to electrically connect the LEDs 23 to the circuit board 21 through the through groove 224. The LEDs 23 can have the same color of light or various kinds of colors including red, green or blue. In this embodiment, the LEDs 23 can be LED chips, but in practical use, lamp type LEDs or surface mount type LEDs can also be adopted.

The reflective layer 25 is opaque. It is arranged in the through groove 224 and seals the through groove 224 to avoid the circuit board 21 from oxidation due to exposure to atmosphere to be. In another aspect, the reflective layer 25 can avoid light reflecting from the circuit board 21, but the reflective layer 25 reflect light upwardly instead. Thus the illumination uniformity of the light source module can be improved.

Accordingly, instead of being arranged on the circuit board 21, the LEDs 23 in the present invention are arranged on the bottom wall 221 of the metal base 22. The LEDs 23 and conductive traces on the circuit board 21 are located on two levels with different heights. There are only LEDs 23 arranged on the bottom wall 221 (namely no conductive trace is arranged on the bottom wall 221). Therefore, more LEDs 23 can be added on the bottom wall 221 to increase the total illumination intensity of the light source module. In another aspect, there are only conductive traces on the circuit board 21 (namely no LEDs 23 is on the circuit board 21). The layout of the conductive traces 13 will not be affected by any LEDs 14, and the difficultness of the arranging those conductive traces 13 can be lowered down.

In addition, as FIG. 4 shows, a convex surface 251 can be formed on the upper face of the reflective layer 25. The convex surface 251 can be used for reflecting light toward specific direction and changing the light distribution of the light source module. As FIG. 5 shows, the thickness of the reflective layer 25 can also be reduced in practical use. The through groove 224 is not fully filled up, which is able to change the light distribution.

Further, as FIG. 6 shows, a metal-made reflective film 26 can be disposed on the reflective layer 25 to raise light reflectance. The reflective film 26 can be formed by electroplating, sputtering or coating.

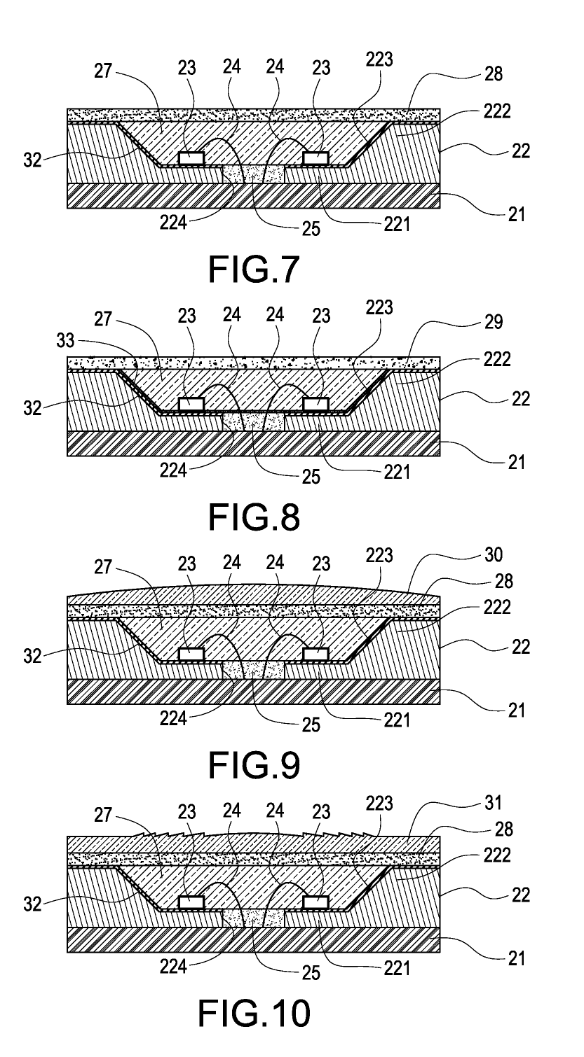

Further, as FIG. 7 shows, an encapsulant layer 27 can be arranged in the recess 223 and a fluorescent layer 28 can be disposed on the encapsulant layer 27. The fluorescent layer 28 can be formed by coating or film-attaching means.

Further, as FIG. 8 shows, a diffusion layer 29 can be disposed on the encapsulant layer 27. The diffusion layer 29 can be formed by coating or film-attaching means. The diffusion layer 29 has a plurality of light diffusion particles therein and can uniform the light distribution. Besides, a fluorescent layer 33 formed on the optical layer 32 is able to transform light with a predetermined wavelength from the LEDs 23 into light with another wavelength.

Further, as FIG. 9 shows, a lens layer 30 can be disposed on the fluorescent layer 28 to converge light from the LEDs 23. Besides, as FIG. 10 shows, a lens layer 31 can be disposed on the diffusion layer 29 to converge light from the LEDs 23. More specifically, the lens layer 31 can be Fresnel lens and not limited thereto.

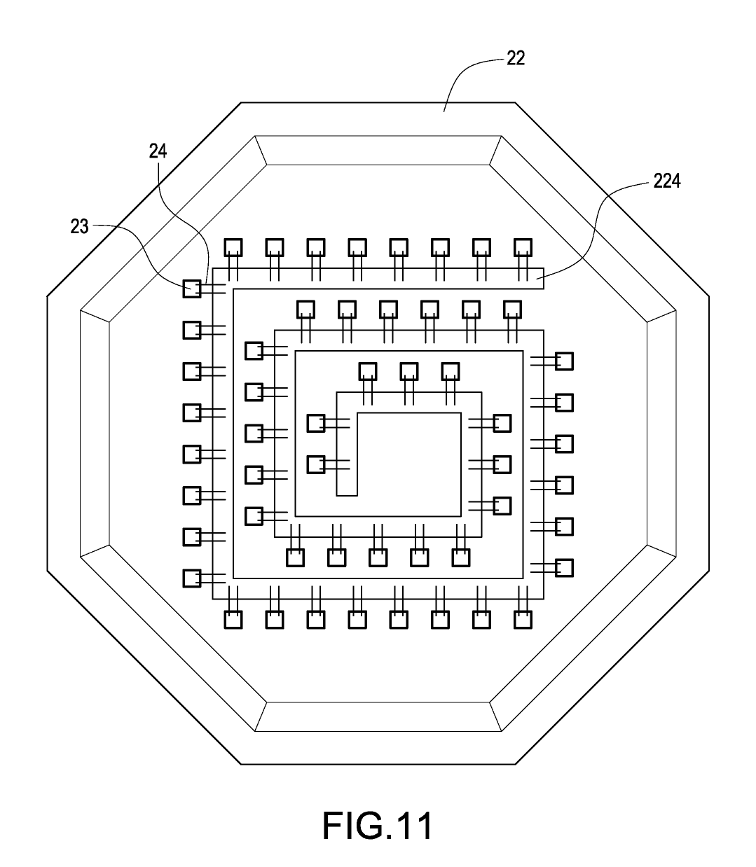

In another aspect, it should be mentioned that the shapes of the circuit board 21, the metal base 22 and the through groove 224 are not limited to rectangular in this embodiment, and can be varied in practical use. For example, as FIG. 11 shows, the shapes of the circuit board 21, the metal base 22 is octagonal, and the shape of the through groove 224 is spiral.

While the invention has been described by means of specific embodiments, numerous modifications and variations could be made thereto by those skilled in the art without departing from the scope and spirit of the invention set forth in the claims.

What is claimed is:

1. A light source module, comprising:
a circuit board;
a metal base arranged on the circuit board and having a bottom wall and a peripheral wall upwardly extending from the bottom wall, the bottom wall and the peripheral wall cooperatively defining a recess, the bottom wall having a through groove exposing the circuit board;
a plurality of LEDs arranged on the bottom wall;
a plurality of bonding wires electrically connecting the LEDs to the circuit board through the through groove; and
a reflective layer arranged in the through groove and sealing the through groove.

2. The light source module as claim 1, wherein the circuit board is a single layer PCB, multilayer PCB, aluminum based PCB, or flexible PCB.

3. The light source module as claim 1, further comprising an optical layer formed on the metal base, wherein the optical layer is made by curing dye-doped liquid material disposed on the metal base.

4. The light source module as claim 3, wherein the dye is photo curable ink or thermal curable ink.

5. The light source module as claim 1, wherein the optical layer is made of mixture of barium sulphate.

6. The light source module as claim 3, further comprising a florescent layer disposed on the optical layer.

7. The light source module as claim 1, further comprising a reflective film disposed on the reflective layer.

8. The light source module as claim 1, further comprising an encapsulant layer disposed in the recess.

9. The light source module as claim 8, further comprising a florescent layer disposed on the encapsulant layer.

10. The light source module as claim 9, further comprising a lens layer disposed on the florescent layer.

11. The light source module as claim 8, further comprising a diffusion layer disposed on the encapsulant layer.

12. The light source module as claim 11, further comprising a lens layer disposed on the diffusion layer.
